(19) United States
(12) Patent Application Publication
(10) Pub. No.: US 2002/0027169 A1
(43) Pub. Date: Mar. 7, 2002

(54) Method of selecting devices for air blow system and recording medium storing program for selecting devices for air blow system

(76) Inventors: Mitsuru Senoo, Tsukuba-gun (JP); Hu Ping Zhang, Tsukuba-gun (CN); Naotake Oneyama, Tsukuba-gun (JP)

Correspondence Address: BAKER & BOTTS, 30 ROCKEFELLER PLAZA, NEW YORK, NY, 10112

(21) Appl. No.: 09/941,494

(22) Filed: Aug. 29, 2001

(30) Foreign Application Priority Data
Sep. 4, 2000 (JP) 2000-266443

(51) Int. Cl. B05D 1/00

(52) U.S. Cl. 239/69; 239/1

(57) ABSTRACT

Calculation for determining the optimal nozzle diameter and nozzle immediately upstream pressure for minimizing the compressed air consumption flow rate is facilitated. The nozzle diameter, work distance, and nozzle immediately upstream pressure or blow impact pressure in the present state are inputted as present state values. The compressed air consumption flow rate and the blow impact pressure or the nozzle immediately upstream pressure are computed from the present state values. An improvement value of the nozzle diameter or the nozzle immediately upstream pressure is inputted on the basis of a judgment on the computation results. The compressed air consumption flow rate and the nozzle immediately upstream pressure or the nozzle diameter are computed from the improvement value a necessary number of times. Thus, a nozzle diameter and a nozzle immediately upstream pressure that provide the lowest compressed air consumption flow rate are selected.

### BACKGROUND OF THE INVENTION

1. Field of the Invention

The present invention relates to a method of selecting devices for an air blow system for continuously supplying a jet of compressed air by using a computer. The present invention also relates to a recording medium storing a program for selecting devices for an air blow system.

2. Discussion of Related Art

Air blow is used for various purposes. For example, a continuous jet of compressed air is applied directly to a workpiece to blow off water or chips or to cool it by using various nozzles or a hand-operated air gun. Air blow is also used for suction transportation or other similar work with a vacuum ejector. It is known that the effect of air blow (blow impact pressure, etc.) is determined by the nozzle diameter, the pressure immediately upstream of the nozzle (hereinafter referred to as “the nozzle immediately upstream pressure”, and the work distance (i.e. the distance between the nozzle and the workpiece).

With today's demands for energy conservation, the achievement of energy conservation (i.e. an improvement in utilization efficiency) has become a serious problem to be solved for air blow systems in which compressed air is used continuously. Matters to be realized to achieve energy conservation in an air blow system are minimization of the pressure drop in the piping system and improvement in the effect of air blow. However, it takes much time and labor to perform calculation for minimization of the pressure drop in the air blow system and for improvement in the effect of air blow. Therefore, almost no attempt has heretofore been made to perform such calculation in the prior art.

### SUMMARY OF THE INVENTION

A first object of the present invention is to facilitate calculation for determining the nozzle diameter of an air blow nozzle in an air blow system, together with the nozzle immediately upstream pressure, the blow impact pressure and the work distance, which are optimal for minimizing the compressed air consumption flow rate.

A second object of the present invention is to select upstream piping system devices and a pressure-reducing valve for maintaining the upstream pressure loss in a piping system upstream of the air blow nozzle or the conductance ratio at a predetermined value.

The present invention facilitates calculation for determining the nozzle diameter of an air blow nozzle in an air blow system, together with the nozzle immediately upstream pressure, the blow impact pressure and the work distance, which are optimal for minimizing the compressed air consumption flow rate, and also allows selection of upstream piping system devices and a pressure-reducing valve for maintaining the upstream pressure loss in a piping system upstream of the air blow nozzle or the conductance ratio at a predetermined value.

More specifically, according to a first aspect of the present invention, the nozzle diameter, the work distance, and the nozzle immediately upstream pressure or the blow impact pressure in the present state of the air blow nozzle are inputted as present state values. The compressed air consumption flow rate and the blow impact pressure or the nozzle immediately upstream pressure are computed from the present state values. An improvement value of the nozzle diameter or the nozzle immediately upstream pressure is inputted on the basis of a judgment on the computation results. The compressed air consumption flow rate and the nozzle immediately upstream pressure or the nozzle diameter are computed from the improvement value a necessary number of times. Thus, a nozzle diameter and a nozzle immediately upstream pressure that provide the lowest compressed air consumption flow rate are selected.

According to a second aspect of the present invention, \mathring{1} the nozzle diameter, \mathring{2} the number of nozzles, \mathring{3} one of the nozzle immediately upstream pressure, the blow impact pressure and the pressure-reducing valve secondary pressure; \mathring{4} the composite sonic conductance or the composite effective sectional area, \mathring{5} the piping material, and \mathring{6} the pipe length in the present state of the upstream piping system, which is upstream of the nozzle, are inputted as present state values. An upstream pressure loss or a conductance ratio is inputted as a set value used as a reference when a recommended circuit is selected. The upstream pressure loss and the conductance ratio in the present state are computed from the present state values and the set value.

When the computed upstream pressure loss or conductance ratio in the present state does not satisfy the set value, a recommended circuit electromagnetic valve sonic conductance and a recommended circuit pipe inner diameter that satisfy the set value are computed. Then, upstream piping system devices and a pressure-reducing valve that are conformable to the computed recommended circuit electromagnetic valve sonic conductance and recommended circuit pipe inner diameter are selected.

According to a third aspect of the present invention, the nozzle diameter, the number of nozzles, and the nozzle immediately upstream pressure or the blow impact pressure in a new setup of the nozzle upstream piping system are inputted as new values. An upstream pressure loss or a conductance ratio is inputted as a set value used as a reference when a recommended circuit is selected. A recommended circuit electromagnetic valve sonic conductance and a recommended circuit pipe inner diameter that satisfy the set value are computed from the new values and the set value. Then, upstream piping system devices and a pressure-reducing valve that are conformable to the computed recommended circuit electromagnetic valve sonic conductance and recommended circuit pipe inner diameter are selected.

In the air blow system device selecting method according to the first aspect of the present invention, the nozzle diameter, the work distance, and the nozzle immediately upstream pressure or the blow impact pressure in the present state are inputted as present state values. The compressed air consumption flow rate and the blow impact pressure or the nozzle immediately upstream pressure are computed from the present state values. An improvement value of the nozzle diameter or the nozzle immediately upstream pressure is inputted on the basis of a judgment on the computation results. The compressed air consumption flow rate and the nozzle immediately upstream pressure or the nozzle diameter are computed from the improvement value a necessary number of times, thereby selecting a nozzle diameter and a nozzle immediately upstream pressure that provide the lowest compressed air consumption flow rate. Accordingly, it is possible to facilitate calculation for determining the optimal nozzle diameter and nozzle immediately upstream pressure for minimizing the compressed air consumption flow rate.

In the air blow system device selecting methods according to the second and third aspects of the present invention, upstream piping system devices and a pressure-reducing valve are selected so as to maintain the upstream pressure loss in the piping system upstream of the nozzle or the conductance ratio at a predetermined value.

In addition, the present invention provides a recording medium storing a program for carrying out the device selecting method according to any one of the first to third aspects of the present invention.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a flowchart showing the flow of an embodiment of the method of selecting devices for an air blow system according to the present invention.

FIG. 2 is a flowchart showing the flow of computation at step S3 in FIG. 1.

FIG. 3 is a flowchart showing the flow of computation at step S6 in FIG. 1.

FIG. 4 is a flowchart showing the flow of computation at step S17 in FIG. 1.

FIG. 5 is a flowchart showing the flow of computation at step S23 in FIG. 1.

FIG. 6 is a flowchart showing the flow of computation at step S26 in FIG. 1.

FIG. 7 shows a personal computer screen (optimization of air blow nozzle; improvement) used in the embodiment of the present invention.

FIG. 8 shows a personal computer screen (optimization of air blow nozzle; present state input) used in the embodiment of the present invention.

FIG. 9 shows a personal computer screen (optimization of upstream piping system; present system evaluation) used in the embodiment of the present invention.

FIG. 10 shows a personal computer screen (optimization of upstream piping system; new system) used in the embodiment of the present invention.

### DESCRIPTION OF THE PREFERRED EMBODIMENTS

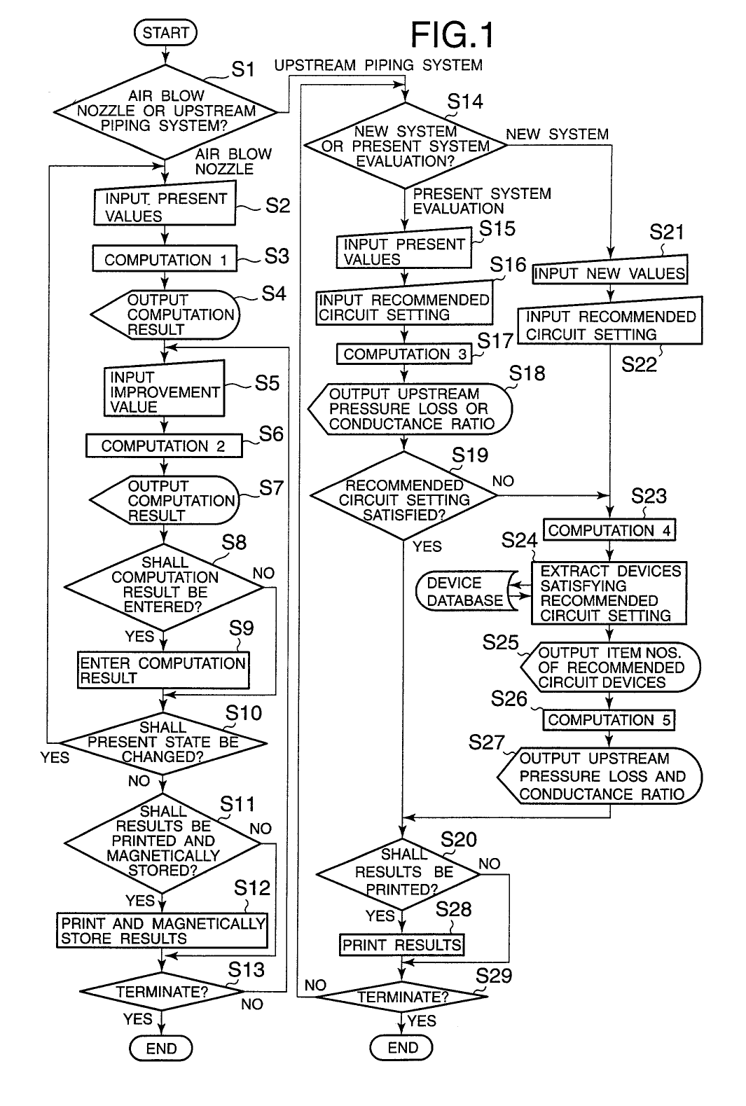

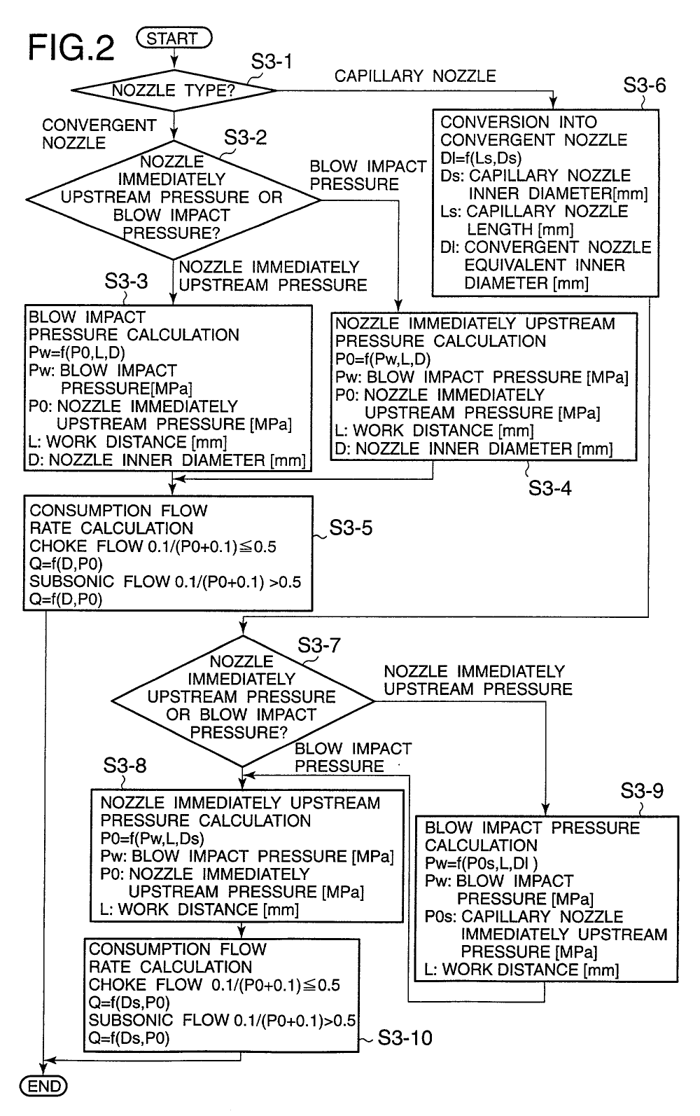

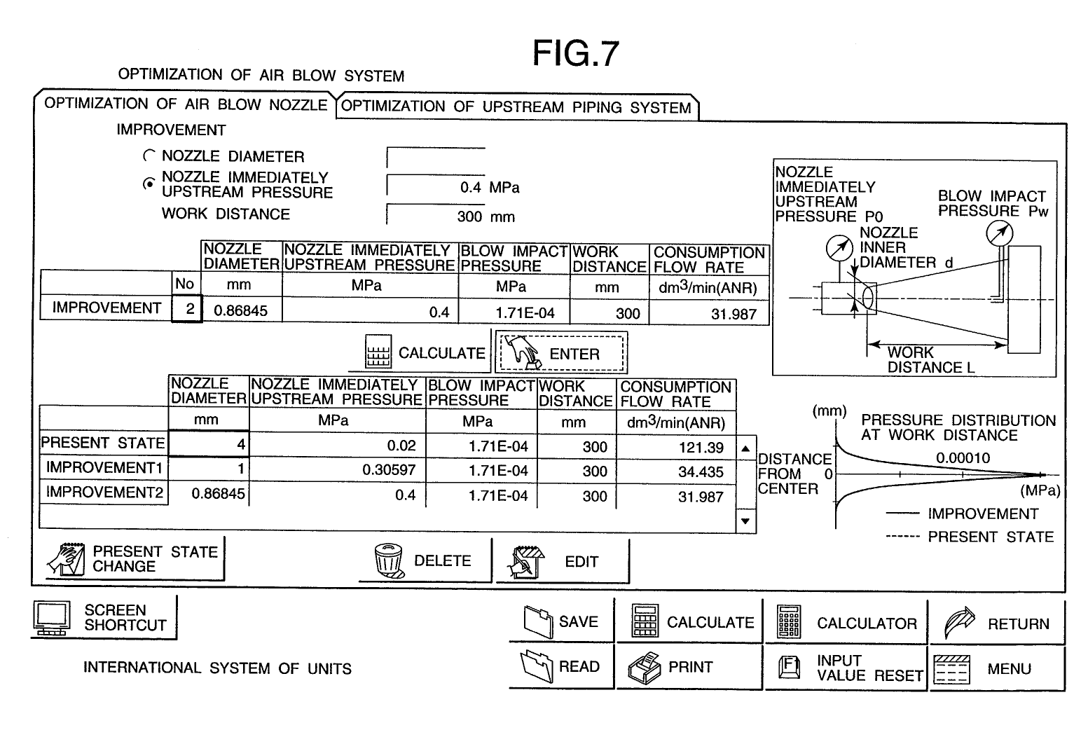

FIGS. 1 to 10 show an embodiment of the method of selecting devices for an air blow system according to the present invention. FIG. 1 is a flowchart showing the flow of the entire operation according to the embodiment of the present invention. FIGS. 2 to 6 are flowcharts showing the computations performed at steps S3, S6, S17, S23 and S26 in FIG. 1. FIGS. 7 to 10 show personal computer screens. While looking at these screens, the operator operates the personal computer to select devices according to the flows shown in FIGS. 1 to 6.

In the embodiment of the present invention, device selection for optimization of an air blow system is divided into optimization of an air blow nozzle and optimization of an upstream piping system. In the optimization of the air blow nozzle, the nozzle diameter of the air blow nozzle, the nozzle immediately upstream pressure, the work distance and the consumption flow rate are optimized under the conditions that the blow impact pressure, which is given as an input condition, is kept constant. In the optimization of the upstream piping system, the item Nos. of upstream piping system devices (an electromagnetic valve and piping) and a pressure-reducing valve are selected so as to satisfy a condition placed upon the upstream pressure loss or the conductance ratio, which is given as an input condition.

When the program of the flowchart shown in FIG. 1 starts, the operator is asked at step S1 whether to choose “Optimization of air blow nozzle” or “Optimization of upstream piping system”. If “Optimization of air blow nozzle” is chosen at step S1 and the tag of “Optimization of air blow nozzle” is clicked on the personal computer screen, the screen is changed to the “Optimization of air blow nozzle” screen displayed in the format as shown in FIG. 7. It should be noted, however, that FIG. 7 shows the state of the air blow nozzle after an improvement operation has been carried out twice. In the screen displayed in the format as shown in FIG. 7 immediately after the screen changing operation, no data has yet been inputted. The “Present state change” button in the lower-left corner of the large box is the “Present state input” button.

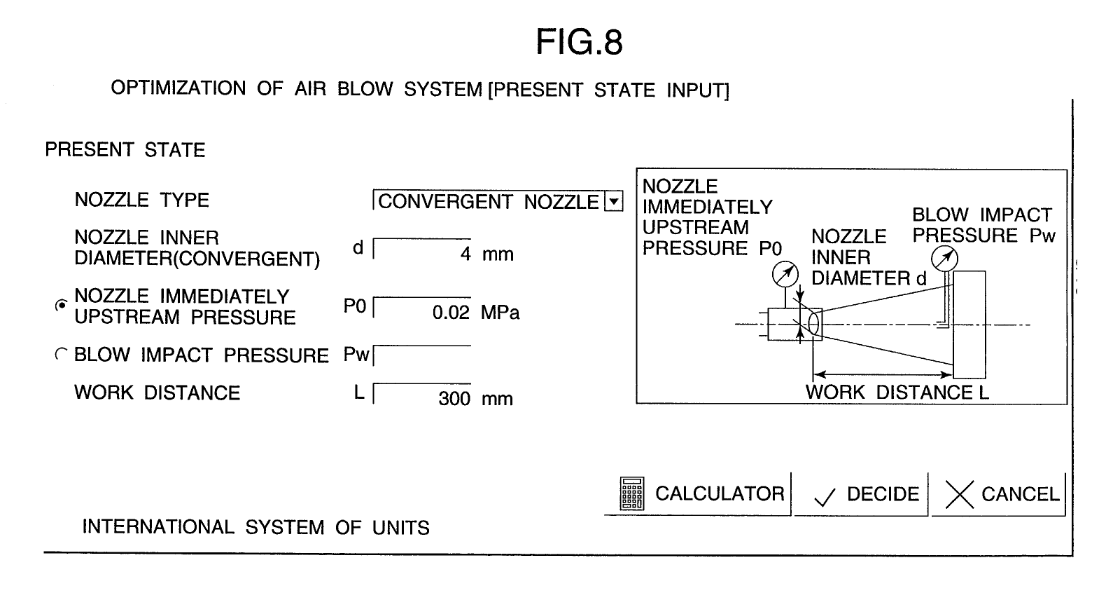

At step S2 in FIG. 1, present state values are inputted. When the “Present state input” button is clicked, the personal computer screen is changed to that shown in FIG. 8. Therefore, the following present state values are inputted in the input boxes shown in FIG. 8: \mathring{1} type of nozzle (convergent nozzle or capillary nozzle) and nozzle length if “capillary nozzle” is chosen; \mathring{2} nozzle diameter (nozzle inner diameter); \mathring{3} nozzle immediately upstream pressure or blow impact pressure; and \mathring{4} work distance. After confirming that there is no error in the inputted present state values in FIG. 8, the operator clicks the “Decide” button in the lower-right corner of the screen. Consequently, the screen is changed to that shown in FIG. 7. Then, if the “Calculate” button is clicked, computation 1 at step S3 is executed.

Computation 1 at step S3 is executed according to the flowchart of FIG. 2. At step S3-1, a judgment is made as to which of “convergent nozzle” and “capillary nozzle” was chosen as a type of nozzle in the input \mathring{1}. If it is judged at step S3-1 that “convergent nozzle” was chosen, a judgment is made at step S3-2 as to which of “nozzle immediately upstream pressure” and “blow impact pressure” was inputted in the input \mathring{3}. If it is judged at step S3-2 that “nozzle immediately upstream pressure” was inputted, calculation of the blow impact pressure is performed at step S3-3 according to the equation shown in the box of step S3-3. If it is judged at step S3-2 that “blow impact pressure” was inputted, calculation of the nozzle immediately upstream pressure is performed at step S3-4 according to the equation shown in the box of step S3-4.

After the calculation has been performed at step S3-3 or step S3-4, calculation of the compressed air consumption flow rate is performed at step S3-5 according to the equation shown in the box of step S3-5.

If it is judged at step S3-1 that “capillary nozzle” was chosen, the inner diameter of the capillary nozzle is converted into the inner diameter of the convergent nozzle at step S3-6. The conversion is performed according to the equation shown in the box of step S3-6. Then, the process proceeds to step S3-7, at which a judgment is made as to which of “nozzle immediately upstream pressure” and “blow impact pressure” was inputted in the input \mathring{3}. If it is judged at step S3-7 that “blow impact pressure” was inputted, calculation of the nozzle immediately upstream pressure is performed at step S3-8 according to the equation shown in the box of step S3-8. Then, the process proceeds to step S3-10. If it is judged at step S3-7 that “nozzle immediately upstream pressure” was inputted, calculation of the blow impact pressure is performed at step S3-9 according to the equation shown in the box of step S3-9. Then, the process proceeds to step S3-8. At step S3-10, calculation of the compressed air consumption flow rate is performed according to the equation shown in the box of step S3-10. After the calculation has been performed at step S3-5 or S3-10, the process proceeds to step S4 in FIG. 1.

At step S4 in FIG. 1, the result of computation 1 at step S3 is outputted, and the value (present state) of the computation result is displayed in the box in the left-upper part of FIG. 7. Next, if the “Enter” button in FIG. 7 is clicked, the value (present state) of the computation result is entered in the table below the “Enter” button. In the input example of the present state values, the convergent nozzle inner diameter is 4 mm. The nozzle immediately upstream pressure is 0.02 MPa, and the work distance is 300 mm. The computed compressed air consumption flow rate is 121.39 dm³/min (ANR). These values are displayed in the entry box (present state) in FIG. 7.

The system is arranged so that computation can be performed a desired number of times necessary for minimization of the consumption flow rate by inputting an improvement value obtained by appropriately changing the nozzle diameter or the nozzle immediately upstream pressure on the basis of a judgment on the above-described computation results under the conditions that the work distance and blow impact pressure of the air blow nozzle are kept constant. In the input example, computation is performed with regard to a case where the nozzle inner diameter is changed to an improvement value of 1 mm (improvement 1) and with regard to a case where the nozzle immediately upstream pressure is changed to an improvement value of 0.4 MPa (improvement 2) to compare each of the computed consumption flow rates with the consumption flow rate in the present state.

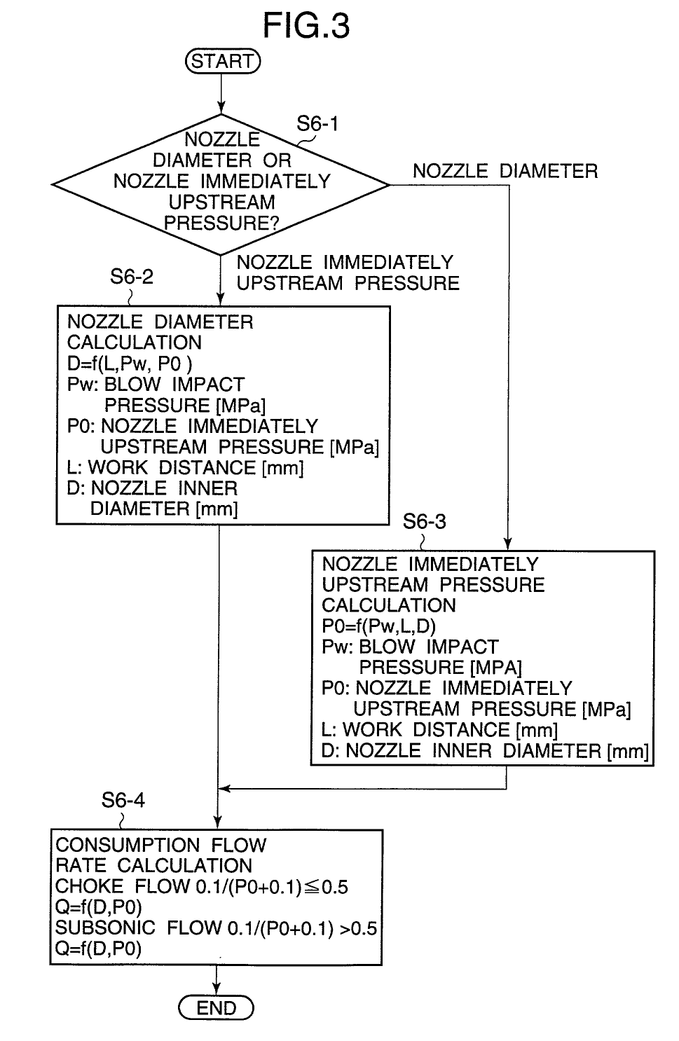

At step S5 in FIG. 1, the data shown in the above-described improvement 1 is inputted as an improvement value, and computation 2 is executed at step S6. Computation 2 at step S6 is executed according to the flowchart of FIG. 3. At step S6-1, a judgment is made as to whether “nozzle diameter” or “nozzle immediately upstream pressure” was inputted as an improvement value. If it is judged at step S6-1 that an improvement value of nozzle diameter was inputted, calculation of the nozzle immediately upstream pressure is performed at step S6-3 according to the equation shown in the box of step S6-3. Then, the process proceeds to step S6-4.

If it is judged at step S6-1 that “nozzle immediately upstream pressure” was inputted as an improvement value, calculation of the nozzle diameter is performed at step S6-2 according to the equation shown in the box of step S6-2. Then, the process proceeds to step S6-4. At step S6-4, calculation of the compressed air consumption flow rate is performed according to the equation shown in the box of step S6-4. Then, the process proceeds to step S7 in FIG. 1.

At step S7 in FIG. 1, the result of computation 2 at step S6 is outputted, and data (improvement 1) concerning the computation result is displayed in the box in the upper-left part of FIG. 7. It should be noted that in FIG. 7 the result of improvement 1 has already been displayed in the entry box.

At step S8 in FIG. 1, a choice is made as to whether or not to enter the computation result of improvement 1. If the operator chooses to enter the computation result at step S8, the computation result is entered at step S9. Then, the process proceeds to step S10. If the operator chooses not to enter the computation result at step S8, the process proceeds to step S10. A choice is made at step S10 as to whether or not to change the present state. If it is necessary to change the present state, the process returns to step S2. If the present state need not be changed, the process proceeds to step S11.

Next, a choice is made at step S11 as to whether or not to print and magnetically store the computation results. If the operator chooses to print and magnetically store the computation results, the computation results are printed and magnetically stored at step S12. Then, the process proceeds to step S13. If the operator chooses not to print and magnetically store the computation results at step S11, the process proceeds to step S13. At step S13, a choice is made as to whether or not to terminate the process. If YES is the answer, the process proceeds to “End”. If the operator chooses not to terminate the process (i.e. a further improvement is needed), the process returns to step S5.

In the input example shown in FIG. 7, improvement 2 is expected. Therefore, the process returns from step S13 to step S5, at which an improvement value for improvement 2 is inputted in the same way as in improvement 1. Then, computation is executed at step S6, and data (improvement 2) concerning the computation result is displayed at step S7. If the computation result of improvement 2 is entered at step S9, items of data concerning the present state, improvement 1 and improvement 2 are displayed in the table shown in FIG. 7. It becomes clear from the table that the consumption flow rate in improvement 2 is the lowest.

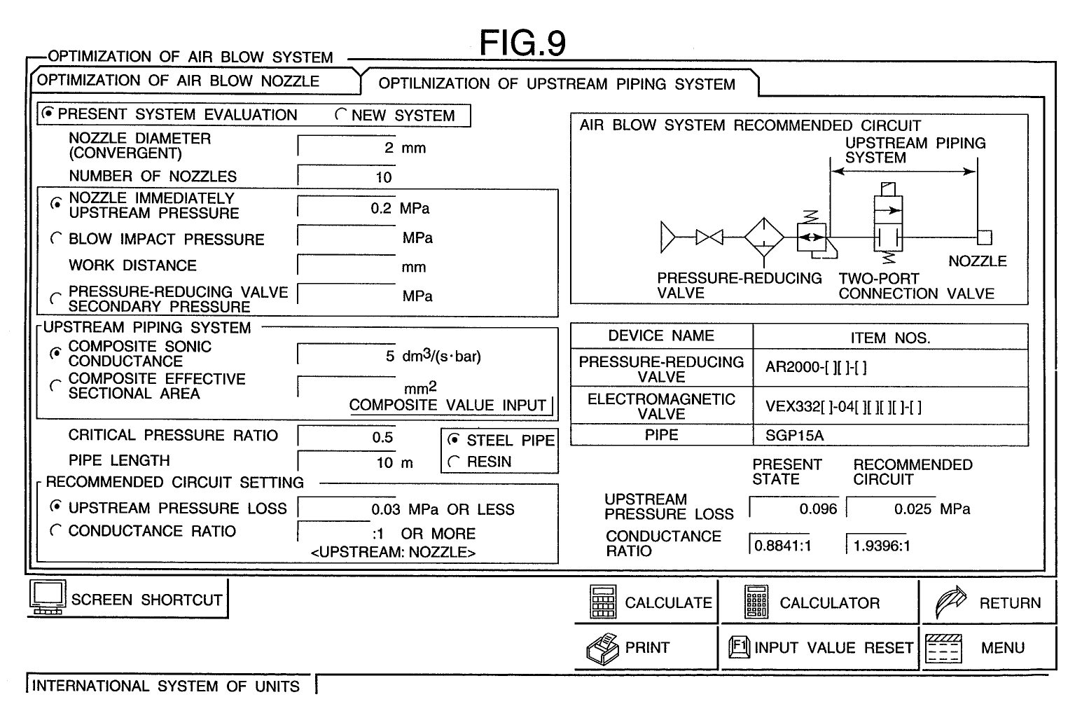

Next, the optimization of the upstream piping system will be described. In the optimization of the upstream piping system, calculation for selection of devices for the piping system, from the pressure-reducing valve to the nozzle, is performed separately for two different cases, i.e. evaluation of the present system, and device selection for a new system. If “Optimization of upstream piping system” is chosen at step S1 in FIG. 1 and the tag of “Optimization of upstream piping system” is clicked on the personal computer screen, the screen is changed to the “Optimization of upstream piping system” screen displayed in the format as shown in FIG. 9. Immediately after the screen changing operation, no data has yet been inputted in any of the boxes of the “Optimization of upstream piping system” screen. FIG. 9, however, shows the final stage of the present system evaluation process, items of data according to an input example are displayed in the screen shown in FIG. 9.

At step S14 in FIG. 1, the operator is asked to choose between “New system” and “Present system evaluation”. If “Present system evaluation” is chosen, present state values are inputted at step S15. Then, the process proceeds to step S16. In FIG. 9, “Present system evaluation” in the uppermost part of the left box is clicked, and present state values are successively inputted in input boxes below the display of “Present system evaluation”. More specifically, the following values are inputted as present state values: \mathring{1} nozzle diameter; \mathring{2} number of nozzles; \mathring{3} one of the three, i.e. nozzle immediately upstream pressure, blow impact pressure (and work distance), and pressure-reducing valve secondary pressure; \mathring{4} either one of “composite sonic conductance” (defined by ISO; when composite sonic conductance is inputted, critical pressure ratio is also inputted) and “composite effective sectional area” (defined by JIS) of the upstream piping system; \mathring{5} piping material (steel pipe or resin pipe); and \mathring{6} pipe length. It should be noted that “composite sonic conductance” and “composite effective sectional area” indicate the flowability of fluid in the upstream piping system. The critical pressure ratio is the pressure ratio at the boundary where choke flow and subsonic flow change from one to the other. The pressure ratio is [secondary pressure]/[primary pressure].

At step S16 in FIG. 1, recommended circuit setting data is inputted, and computation 3 is executed at step S17. The recommended circuit setting data is used as reference data when a recommended circuit is selected. As shown in FIG. 9, either “Upstream pressure loss” or “Conductance ratio” is chosen, and a set value is inputted. It should be noted that [conductance ratio] is [“composite sonic conductance” or “composite effective sectional area” of the upstream devices]/[“sonic conductance” or “effective sectional area” of the nozzle]. Next, the “Calculate” button in FIG. 9 is clicked to execute computation 3 at step S17.

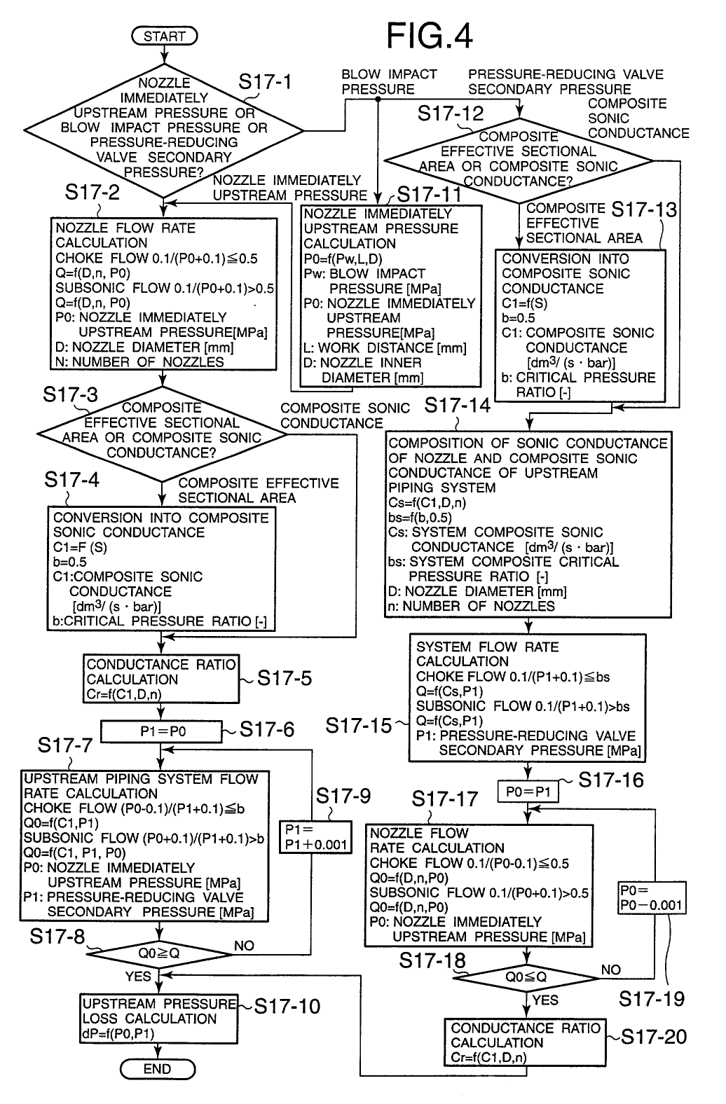

Computation 3 at step S17 is executed according to the flowchart of FIG. 4. At step S17-1, a judgment is made as to which of “Nozzle immediately upstream pressure”, “Blow impact pressure” and “Pressure-reducing valve secondary pressure” was selected as the present state value \mathring{3}. If it is judged at step S17-1 that “Nozzle immediately upstream pressure” was selected, calculation of the flow rate Q in the nozzle is performed at step S17-2 according to the equation shown in the box of step S17-2. Then, the process proceeds to step S17-3.

At step S17-3, a judgment is made as to which of “Composite effective sectional area” and “Composite sonic conductance” was chosen as the present state value \mathring{4}. If it is judged at step S17-3 that “Composite effective sectional area” was chosen, calculation for converting “composite effective sectional area” into “composite sonic conductance” is performed at step S17-4 according to the equation shown in the box of step S17-4. Then, the process proceeds to step S17-5.

At step S17-5, calculation of the conductance ratio is performed according to the equation shown in the box of step S17-5. At step S17-6, the pressure-reducing valve secondary pressure P1 is set equal to the nozzle immediately upstream pressure P0. Then, the process proceeds to step S17-7. If it is judged at step S17-3 that “Composite sonic conductance” was chosen, the process proceeds to step S17-5.

At step S17-7, calculation of the flow rate Q0 in the upstream piping system is performed according to the equation shown in the box of step S17-7. Then, it is judged at step S17-8 whether the upstream piping system flow rate Q0 is not less than the nozzle flow rate Q. If it is judged at step S17-8 that the flow rate Q0 is not less than the flow rate Q, calculation of the upstream pressure loss is performed at step S17-10 according to the equation shown in the box of step S17-10. Then, the process proceeds to step S18 in FIG. 1. If it is judged at step S17-8 that the flow rate Q0 is less than the flow rate Q, P1 is set equal to P1+0.001 at step S17-9. Then, the process returns to step S17-7.

If it is judged at step S17-1 that “Blow impact pressure” was selected as a present state value, calculation for obtaining the nozzle immediately upstream pressure is performed at step S17-11 according to the equation shown in the box of step S17-11. Then, the process proceeds to step S17-2.

If it is judged at step S17-1 that “Pressure-reducing valve secondary pressure” was selected as a present state value, a judgment is made at step S17-12 as to which of “Composite effective sectional area” and “Composite sonic conductance” was chosen as the present state value \mathring{4}. If it is judged at step S17-12 that “Composite effective sectional area” was chosen, the same calculation as at step S17-4 is performed at step S17-13. Then, the process proceeds to step S17-14. If it is judged at step S17-12 that “Composite sonic conductance” was chosen, the process proceeds to step S17-14.

At step S17-14, composition of the sonic conductance of the nozzle and the composite sonic conductance of the upstream piping system is performed according to the equation shown in the box of step S17-14. Then, the process proceeds to step S17-15. At step S17-15, calculation of the flow rate Q in the system is performed according to the equation shown in the box of step S17-15. Then, the process proceeds to step S17-16.

At step S17-16, the nozzle immediately upstream pressure P0 is set equal to the pressure-reducing valve secondary pressure P1. Then, the process proceeds to step S17-17. At step S17-17, calculation of the flow rate Q0 in the nozzle is performed according to the equation shown the box of step S17-17. Then, a judgment is made at step S17-18 as to whether the nozzle flow rate Q0 is not more than the system flow rate Q. If it is judged at step S17-18 that the flow rate Q0 is not more than the flow rate Q, calculation of the conductance ratio is performed at step S17-20 according to the equation shown in the box of step S17-20. Then, the process proceeds to step S17-10. If it is judged at step S17-18 that the flow rate Q0 is more than the flow rate Q, P0 is set equal to P0−0.001 at step S17-19. Then, the process returns to step S17-17.

The computation result obtained at step S17 in FIG. 1, i.e. the upstream pressure loss or the conductance ratio, is outputted at step S18. Then, a judgment is made at step S19 as to whether or not the computation result obtained at step S17 satisfies the set value (inputted at step S16) of the recommended circuit. If it is judged at step S19 that the computation result obtained at step S17 satisfies the set value of the recommended circuit, the process proceeds to step S20. If NO is the answer at step S19, the process proceeds to step S23.

In the input example shown in FIG. 9, the present state values are as follows. The nozzle inner diameter is 2 mm; the number of nozzles is 10; the nozzle immediately upstream pressure is 0.2 MPa; the composite sonic conductance is 5 dm³/(s.bar); the critical pressure ratio is 0.5; the pipe length is 10 m; and the piping material is steel pipe. Regarding the set value of the recommended circuit, the upstream pressure loss is set at 0.03 MPa or less. The computation results are displayed in the lower-right corner of the large box in FIG. 9. The upstream pressure loss in the present state is 0.096 MPa, and the conductance ratio in the present state is 0.8841:1. The present state values do not satisfy the set values of the recommended circuit.

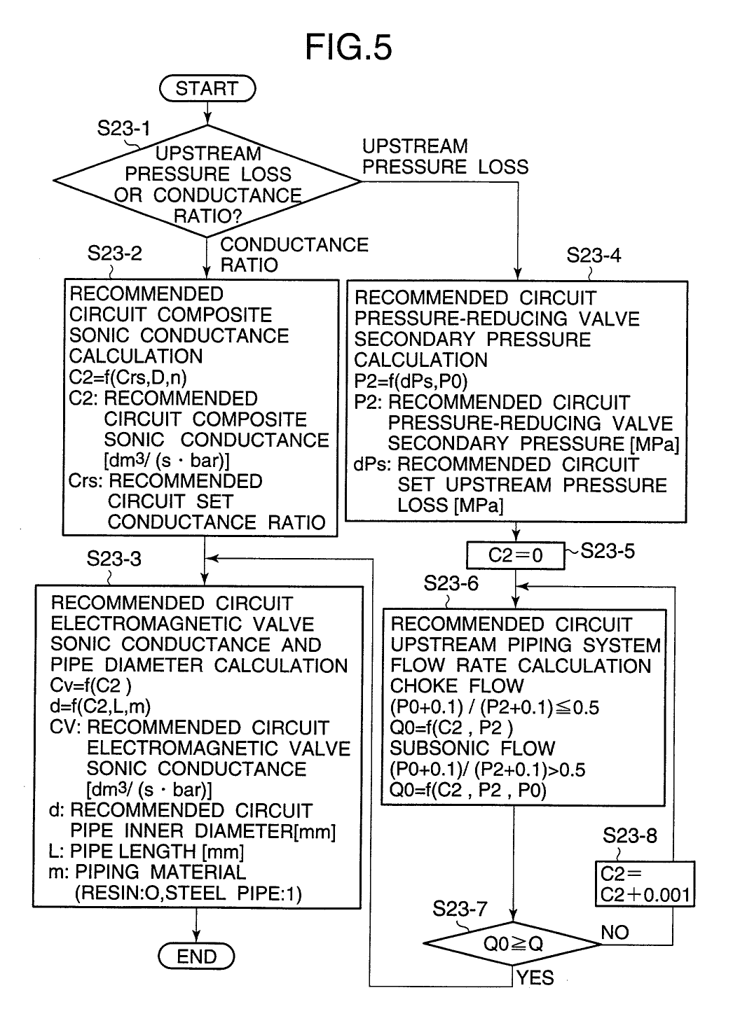

At step S23, calculation is performed to obtain an electromagnetic valve sonic conductance and a pipe inner diameter that satisfy the set value inputted at step S16 or step S22. Then, the process proceeds to step S24. Computation 4 at step S23 is executed according to the flowchart of FIG. 5.

At step S23-1 in FIG. 5, a judgment is made as to which of “Upstream pressure loss” and “Conductance ratio” was inputted at the recommended circuit setting step. If it is judged at step S23-1 that “Conductance ratio” was inputted, calculation of the recommended circuit composite sonic conductance is performed at step S23-2 according to the equation shown in the box of step S23-2. Then, the process proceeds to step S23-3.

If it is judged at step S23-1 that “Upstream pressure loss” was inputted, calculation of the recommended circuit pressure-reducing valve secondary pressure is performed at step S23-4 according to the equation shown in the box of step S23-4. Then, the process proceeds to step S23-5. At step S23-5, the recommended circuit composite sonic conductance C2 is set equal to 0. Then, the process proceeds to step S23-6.

At step S23-6, calculation of the flow rate Q0 in the upstream piping system of the recommended circuit is performed according to the equation shown in the box of step S23-6. Then, a judgment is made at step S23-7 as to whether the recommended circuit upstream piping system flow rate Q0 is not less than the nozzle flow rate Q. If it is judged at step S23-7 that the flow rate Q0 is not less than the flow rate Q, the process proceeds to step S23-3. If it is judged at step S23-7 that the flow rate Q0 is less than the flow rate Q, C2 is set equal to C2+0.001 at step S23-8. Then, the process returns to step S23-6.

At step S23-3, calculation of the sonic conductance of the electromagnetic valve in the recommended circuit and the pipe inner diameter of the recommended circuit is performed according to the equations shown in the box of step S23-3. Then, the process proceeds to step S24 in FIG. 1. At step S24, upstream piping system devices (an electromagnetic valve and piping) and a pressure-reducing valve that satisfy the set value of the recommended circuit are extracted on the basis of the computation results obtained at step S23 and by reference to information stored in a device database. Then, the process proceeds to step S25. It should be noted that the device database includes a valve database and a pipe database, in which data on devices to be selected, i.e. valves (pressure-reducing valves and electromagnetic valves) and pipes, have been stored in advance (i.e. data such as item Nos., names, inner diameters, and pipe friction factors). At step S25, the item Nos. of the recommended circuit devices are outputted and displayed in the item No. boxes corresponding to the device names (pressure-reducing valve, electromagnetic valve, and pipe) in FIG. 9. Then, the process proceeds to step S26.

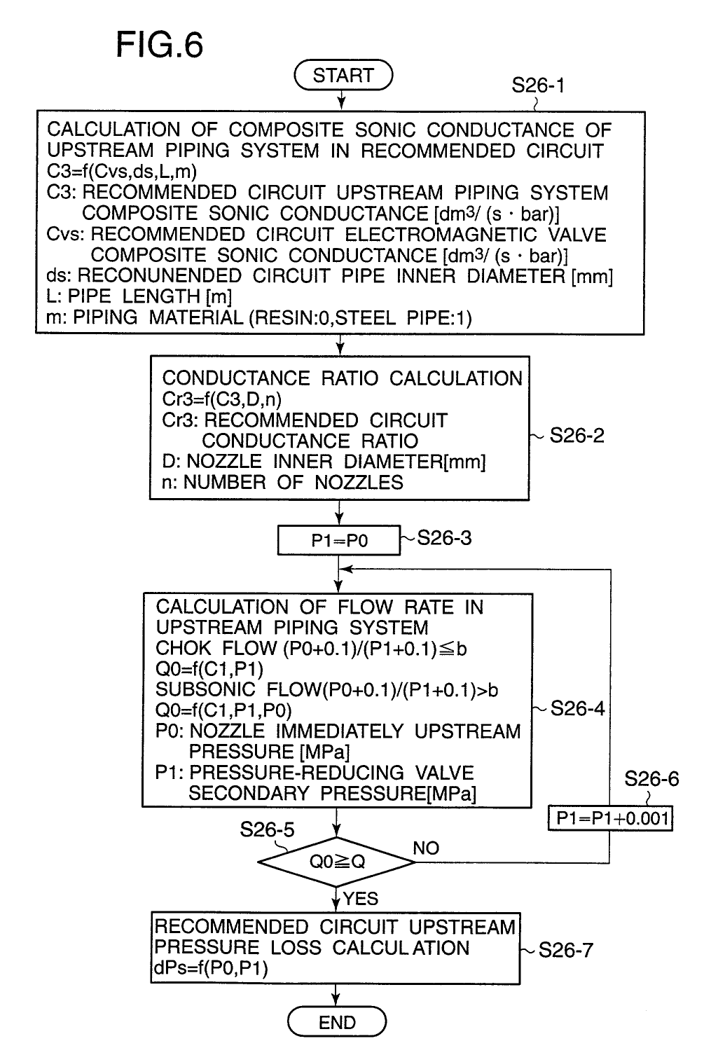

At step S26, computation 5 is executed according to the flowchart of FIG. 6, and the computation result is outputted at step S27. At step S26-1 in FIG. 6, calculation of the composite sonic conductance of the upstream piping system in the recommended circuit is performed according to the equation shown in the box of step S26-1. Subsequently, calculation of the conductance ratio is performed at step S26-2 according to the equation shown in the box of step S26-2. At step S26-3, the pressure-reducing valve secondary pressure is set equal to the nozzle immediately upstream pressure P0. At step S26-4, calculation of the flow rate Q0 in the upstream piping system is performed according to the equation shown in the box of step S26-4. Then, a judgment is made at step S26-5 as to whether the flow rate Q0 in the upstream piping system is not less than the flow rate Q in the nozzle. If it is judged at step S26-5 that the flow rate Q0 is not less than the flow rate Q, calculation of the upstream pressure loss in the recommended circuit is performed at step S26-7 according to the equation shown in the box of step S26-7. Then, the process proceeds to step S27 in FIG. 1. If it is judged at step S26-5 that the flow rate Q0 is less than the flow rate Q, P1 is set equal to P1+0.001 at step S26-6. Then, the process returns to step S26-4.

At step S27, the upstream pressure loss and the conductance ratio are outputted, and data is displayed in the recommended circuit box (in the lower-right corner of the large box) in FIG. 9. In the input example shown in FIG. 9, the upstream pressure loss in the recommended circuit obtained at step S26 is 0.025 MPa, and the conductance ratio is 1.9396:1. Thus, it becomes clear that the upstream pressure loss satisfies the set condition.

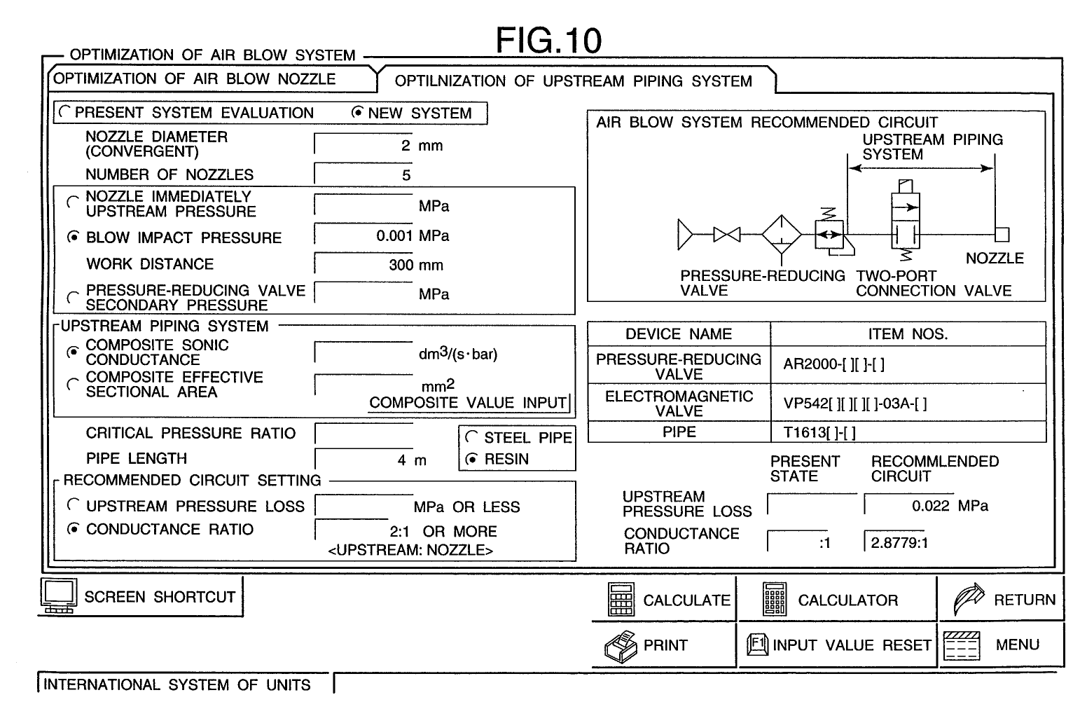

If “New system” is chosen at step S14 in FIG. 1, new values are inputted at step S21. Then, the process proceeds to step S22. On the personal computer screen, “New system” is clicked, and pieces of new data are successively inputted in the input boxes below the display of “New system” in FIG. 10. More specifically, the following values are inputted as new values: nozzle diameter; number of nozzles; either one of nozzle immediately upstream pressure and blow impact pressure (and the work distance); piping material (“Steel pipe” or “Resin pipe”); and pipe length. It should be noted that “Pressure-reducing valve secondary pressure” is assumed to be unknown in the case of device selection for a new system. Therefore, data concerning “Pressure-reducing valve secondary pressure” is not inputted in this case.

At step S22, either one of “Upstream pressure loss” and “Conductance ratio” is chosen, and a set value of the chosen one is inputted as a set value of a recommended circuit. Then, the “Calculate” button in FIG. 10 is clicked to execute computation 4 at step S23. Processing carried out at steps S23 to S27 is the same as that described above.

In the input example shown in FIG. 10, the new values are as follows: the nozzle inner diameter is 2 mm; the number of nozzles is 5; the blow impact pressure is 0.001 MPa; the work distance is 300 mm; the pipe length is 4 m; and the piping material is “Resin”. As a set value, a conductance ratio of 2:1 or more is inputted. Item Nos. of devices outputted at step S25 are displayed in FIG. 10. The upstream pressure loss outputted at step S26 is 0.022 MPa, and the conductance ratio is 2.8779:1. Thus, it is proved that the condition set at step S22 is satisfied.

The operator is asked at step S20 whether or not to print the results. If the operator chooses to print the results. The results are printed at step S28. Then, the process proceeds to step S29. If the operator chooses not to print the results at step S20, the process proceeds to step S29. At step S29, the operator is asked whether or not to terminate the process. If NO is the answer, the process returns to step S14. If the operator chooses to terminate the process, the process ends.

It should be noted that the present invention is not limited to the foregoing embodiments but can be modified in a variety of ways.

What is claimed is:

1. A method of selecting devices for an air blow system by using a programmed computer, said method comprising the steps of:
inputting a nozzle diameter, a work distance, and either one of a nozzle immediately upstream pressure and a blow impact pressure in a present state as present state values;
computing a compressed air consumption flow rate and either one of a blow impact pressure and a nozzle immediately upstream pressure from the present state values;
inputting an improvement value of either one of the nozzle diameter and the nozzle immediately upstream pressure on a basis of a judgment on computation results; and
computing a compressed air consumption flow rate and either one of a nozzle immediately upstream pressure and a nozzle diameter from the improvement value a necessary number of times, thereby selecting a nozzle diameter and a nozzle immediately upstream pressure that provide a lowest compressed air consumption flow rate.

2. A method of selecting devices for an air blow system by using a programmed computer, said method comprising the steps of:
inputting \mathring{1} a nozzle diameter, \mathring{2} a number of nozzles, \mathring{3} one of a nozzle immediately upstream pressure, a blow impact pressure, and a pressure-reducing valve secondary pressure, \mathring{4} either one of a composite sonic conductance and a composite effective sectional area, \mathring{5} a piping material, and \mathring{6} a pipe length in a present state as present state values;
inputting either one of an upstream pressure loss and a conductance ratio as a set value used as a reference when a recommended circuit is selected; and
computing an upstream pressure loss and a conductance ratio in the present state from the present state values and the set value.

3. The method of claim 2, further comprising the steps of:
computing, when the computed upstream pressure loss or conductance ratio in the present state does not satisfy the set value, a recommended circuit electromagnetic valve sonic conductance and a recommended circuit pipe inner diameter that satisfy the set value; and
selecting upstream piping system devices and a pressure-reducing valve that are conformable to the computed recommended circuit electromagnetic valve sonic conductance and recommended circuit pipe inner diameter.

4. A method of selecting devices for an air blow system by using a programmed computer, said method comprising the steps of:
inputting a nozzle diameter, a number of nozzles, and either one of a nozzle immediately upstream pressure and a blow impact pressure in a new system as new values;
inputting either one of an upstream pressure loss and a conductance ratio as a set value used as a reference when a recommended circuit is selected;
computing a recommended circuit electromagnetic valve sonic conductance and a recommended circuit pipe inner diameter that satisfy the set value from the new values and the set value; and
selecting upstream piping system devices and a pressure-reducing valve that are conformable to the computed recommended circuit electromagnetic valve sonic conductance and recommended circuit pipe inner diameter.

5. A recording medium storing a program for selecting devices for an air blow system by using a computer, said program comprising the steps of:
inputting a nozzle diameter, a work distance, and either one of a nozzle immediately upstream pressure and a blow impact pressure in a present state as present state values;
computing a compressed air consumption flow rate and either one of a blow impact pressure and a nozzle immediately upstream pressure from the present state values;
inputting an improvement value of either one of the nozzle diameter and the nozzle immediately upstream pressure on a basis of a judgment on computation results; and
computing a compressed air consumption flow rate and either one of a nozzle immediately upstream pressure and a nozzle diameter from the improvement value a necessary number of times, thereby selecting a nozzle diameter and a nozzle immediately upstream pressure that provide a lowest compressed air consumption flow rate.

6. A recording medium storing a program for selecting devices for an air blow system by using a computer, said program comprising the steps of:
inputting \mathring{1} a nozzle diameter, \mathring{2} a number of nozzles, \mathring{3} one of a nozzle immediately upstream pressure, a blow impact pressure, and a pressure-reducing valve secondary pressure, \mathring{4} either one of a composite sonic conductance and a composite effective sectional area, \mathring{5} a piping material, and \mathring{6} a pipe length in a present state as present state values;
inputting either one of an upstream pressure loss and a conductance ratio as a set value used as a reference when a recommended circuit is selected; and
computing an upstream pressure loss and a conductance ratio in the present state from the present state values and the set value.

7. The recording medium of claim 6, wherein said program further comprises the steps of:
computing, when the computed upstream pressure loss or conductance ratio in the present state does not satisfy the set value, a recommended circuit electromagnetic valve sonic conductance and a recommended circuit pipe inner diameter that satisfy the set value; and
selecting upstream piping system devices and a pressure-reducing valve that are conformable to the computed recommended circuit electromagnetic valve sonic conductance and recommended circuit pipe inner diameter.

8. A recording medium storing a program for selecting devices for an air blow system by using a computer, said program comprising the steps of:
inputting a nozzle diameter, a number of nozzles, and either one of a nozzle immediately upstream pressure and a blow impact pressure in a new system as new values;
inputting either one of an upstream pressure loss and a conductance ratio as a set value used as a reference when a recommended circuit is selected;
computing a recommended circuit electromagnetic valve sonic conductance and a recommended circuit pipe inner diameter that satisfy the set value from the new values and the set value; and
selecting upstream piping system devices and a pressure-reducing valve that are conformable to the computed recommended circuit electromagnetic valve sonic conductance and recommended circuit pipe inner diameter.
